(19) United States
(12) Patent Application Publication
(10) Pub. No.: US 2009/0046874 A1
(43) Pub. Date: Feb. 19, 2009

(54) Apparatus and Method for Transmitting Auditory Bone Conduction

(76) Inventor: G. Alexander Doman, Ogden, UT (US)

Correspondence Address: KIRTON AND MCCONKIE, 60 EAST SOUTH TEMPLE,, SUITE 1800, SALT LAKE CITY, UT, 84111, US

(21) Appl. No.: 12/193,155

(22) Filed: Aug. 18, 2008

Related U.S. Application Data
(60) Provisional application No. 60/956,464, filed on Aug. 17, 2007.

(51) Int. Cl. H04R 25/00; H04R 1/08

(52) U.S. Cl. 381/151; 381/326

(57) ABSTRACT

Headwear adapted to transmit personal auditory sound waves via bone conduction and methods pertaining thereto are described. A bone conduction apparatus includes one or more bone conduction oscillators detachably affixed to an article of headwear and adapted to receive electrical signals and transmit auditory sound waves via bone conduction. The oscillators are attached to the headwear such that they remain in substantially constant and consistent contact with the head when the article is worn by a user. Further, the bone conduction oscillators may be waterproof, substantially flat, and malleable such that the article can be worn comfortably during a range of physical activities and in a range of adverse environmental conditions while maintaining such contact. Likewise, the bone conduction apparatus as a whole can be comfortably worn in concert with other headwear including a complementary air conduction device (e.g. headphones).

### CROSS-REFERENCE TO RELATED APPLICATIONS

This application claims the benefit of U.S. Provisional Application No. 60/956,464, filed Aug. 17, 2007, which is incorporated by reference.

### BACKGROUND OF THE INVENTION

1. Field of the Invention

The present invention relates to personal audio listening devices and associated methods. In particular, the present invention is directed to headwear adapted to transmit personal auditory sound waves via bone conduction and methods pertaining thereto.

2. Background and Related Art

Traditionally, most personal audio listening devices utilize air conduction to transmit audio sound waves via the ear canal. There exist several drawbacks to sound waves transmitted in this manner. For example, devices utilizing air conduction often obstruct the ear canal making it difficult or impossible for the user to detect ambient noise. Further, such devices are often unusable for those with outer ear disorders or malformations and uncomfortable for those with visual impairment. Likewise, devices utilizing air conduction can cause hearing damage or even loss resulting from damage to the cochlea. Moreover, devices utilizing air conduction to transmit audio sound waves are of limited or no use in water since such waves propagate differently in water than in air. Likewise, air conduction devices are of limited use in very noisy environments due to competing sound waves in the air. Finally, devices utilizing air conduction are often cumbersome thereby limiting or preventing the use of headwear such as glasses, helmets, hats, beanies, swim caps, visors, skull caps, do rags, acoustic or thermal earmuffs, earplugs, facemasks, bandannas, headbands, sleep or therapeutic eye masks, hair clips or other hair accessories, headlamps, hoods, goggles and the like.

Another common method employed in personal audio listening devices to transmit audio sound waves is bone conduction. Bone conduction is the direct transfer of sound waves to the cochlea of the inner ear through the bones in the skull. Transmitting audio sound waves in this manner has been employed to overcome several of the previously mentioned drawbacks of air conduction. For example, bone conduction devices can be ergonomically positioned against the temple, cheek or behind the ear thereby leaving the ear canal free from obstruction. Further, such devices provide a range of personal audio listening devices for those with outer ear disorders or malformations and for those with visual impairment. Moreover, such devices can be used in water or very noisy environments to deliver exceptional sound clarity. However, despite these advantages, contemporary bone conduction devices and methods have many of the same drawbacks as conventional air conduction devices. For example, contemporary bone conduction devices are often even more cumbersome, thereby further limiting or preventing the use of additional headwear as previously discussed.

There are several additional drawbacks to contemporary bone conduction devices. For example, bone conduction necessarily requires constant and consistent contact between the user's head and the associated device such that sound wave vibrations can be continuously administered. To facilitate this requirement contemporary devices often require surgical implantation or other invasive, costly and/or long term obligations. Other contemporary bone conduction devices lack such continuity thereby delivering distorted, muffled or otherwise irregular and diminished sound quality. Still other contemporary devices are extremely bulky and awkward making them unattractive and/or difficult to use while engaging in physical activity.

Some attempts have been proposed whereby both air conduction and bone conduction are administered by a single device in an effort to enhance the listening experience. Such devices and associated methods, however, exacerbate the drawbacks associated with independent devices as previously discussed. Additionally, combining air and bone conduction into a single device traditionally increases the bulkiness and expense of the device while minimizing versatility.

Thus, while devices and methods currently exist for transmitting auditory sound waves, challenges still exist. Accordingly, it would be an improvement in the art to augment or even replace current devices and methods.

### SUMMARY OF THE INVENTION

The present invention relates to personal audio listening devices and associated methods of manufacture and use. In particular, the present invention is directed to headwear adapted to transmit personal auditory sound waves via bone conduction and methods pertaining thereto.

Implementation of the present invention provides an improved, more-versatile apparatus and method for transmitting audio sound waves via bone conduction. In general terms, implementation of the invention provides an apparatus is a bone conduction (BC) device which is integrally formed with any type of headwear. Specifically, the apparatus is a BC device integrally incorporated into headbands, hats, beanies, swim caps, visors, skull caps, do rags, acoustic or thermal earmuffs, facemasks, bandannas, helmets, headlamps, hoods, goggles and the like. Further, the device can be used independently or in concert with multiple pieces of headwear including generic air conduction auditory devices.

Incorporating a BC device integrally with various pieces of headwear provides an apparatus that can be used while wearing appropriate headwear for a variety of activities without creating any interference.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates an exemplary tie style headband which integrally incorporates bone conduction (BC) technology;

FIG. 2 illustrates an exemplary tie style headband outfitted with multiple BC oscillators disposed around the circumference of the headband and corresponding wiring means to connect the oscillators to a suitable signal producing unit;

FIG. 3 illustrates an exemplary tie style headband outfitted with multiple BC oscillators disposed around the circumference of the headband and corresponding wireless means to connect the oscillators to a suitable signal producing unit;

FIG. 4 illustrates an exemplary pullover style headband which integrally incorporates BC technology;

FIG. 5 illustrates an exemplary tie style bandanna which integrally incorporates BC technology;

FIG. 6 illustrates an exemplary skull cap which integrally incorporates BC technology;

FIG. 7 illustrates an exemplary hat which integrally incorporates bone conduction technology;

FIG. 8 illustrates an exemplary visor which integrally incorporates BC technology;

FIG. 9 illustrates thermal earmuffs which integrally incorporate BC technology; and

FIG. 10 illustrates additional exemplary headwear which integrally incorporates BC technology.

Together with the following description, the Figures demonstrate the features of the various BC apparatuses and associated methods of manufacture and use. The thickness and configuration of components may appear exaggerated in the Figures for clarity. Likewise, the dimensions depicted are not intended to limit the scope of the device with regard to length, diameter, circumference and the like.

### DETAILED DESCRIPTION OF THE INVENTION

The present invention relates to personal audio listening devices and associated methods of manufacture and use. In particular, the present invention is directed to headwear adapted to transmit personal auditory sound waves via bone conduction and methods pertaining thereto.

The following description supplies specific details in order to provide a thorough understanding. Nevertheless, the skilled artisan would understand that the apparatus and associated method of manufacture and use can be implemented and used without employing these specific details. Indeed, the apparatuses and associated methods of use can be placed into practice by modifying the illustrated apparatuses and associated methods and can be used in conjunction with any apparatus, system, component, and/or technique conventionally used in the industry. For example, while the description below focuses on incorporating the device into headbands, the bone conduction device can be incorporated into headbands, hats, beanies, swim caps, visors, skull caps, do rags, acoustic or thermal earmuffs, facemasks, bandannas, helmets, headlamps, hoods, goggles and the like.

A bone conduction (BC) apparatus is intended to transmit auditory sound waves to the inner ear including the cochlea, vestibular system and the auditory nerve by means of BC oscillators. In general the BC oscillators produce auditory sound waves in the form of vibrations which are transmitted through the bones in the skull such that the sound waves are received in the inner ear.

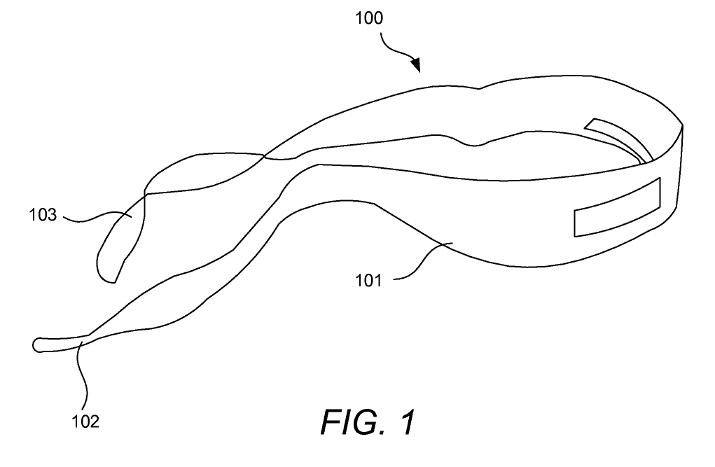

In accordance with some embodiments, a BC apparatus is depicted in FIG. 1. As depicted in FIG. 1, the apparatus is an exemplary tie style headband 100. The tie style headband 100 comprises a length of material 101 defined by two loose ends 102 and 103, respectively. The length of material 101 must be of sufficient span such that it surrounds the head of a user extending from the forehead to the base of the skull leaving adequate excess to form the loose ends 102 and 103. The loose ends 102 and 103 form tie means by which the headband 100 may be affixed to the head of a user (not shown). The exact length of the loose ends 102 and 103 is determined by the head size of an associated user such that the headband 100 can be adjusted to fit any head size. The headband 100 can be composed of any material suitable for wearing around the head and against the skin including cotton, silk, wool, polyester, neoprene, spandex, leather, microfiber, latex, rubber, silicone and other like materials and blends.

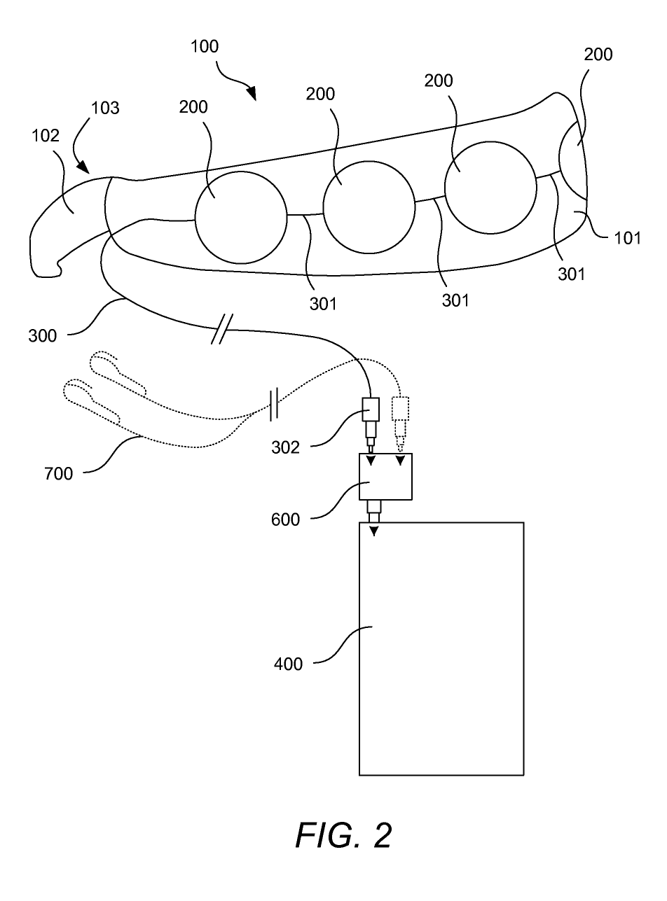

With reference to FIG. 2, in some embodiments a BC device is integrally incorporated in the headband apparatus 100. The BC device includes BC oscillators 200 and an appropriate means for transmitting an audio signal to the oscillators 200. As depicted in FIG. 2, the BC oscillators 200 may be disposed around a portion of the headband 100 that contacts the head of an associated user. However, the BC oscillators 200 need not be disposed around the entire contacting portion of the headband 100 but rather may be disposed only at particular discrete locations such as where the headband 100 contacts the forehead, the temple, just behind the ear, the base of the skull or at any location over the crown or top of the skull. In this manner the BC apparatus of the headband 100 provides consistent yet comfortable contact between the oscillators 200 and the head of an associated user.

Moreover, in some embodiments the BC oscillator 200 or BC oscillators may be disposed throughout the BC apparatus at any discrete location or plurality of locations on the head of a user including against the cheek bone, the jaw bone, the frontal bone, the occipital bone, the parietal bone, the glabella, the mandible, the mastoid bone, the temporal bone, the sphenoid bone, the optic foramen or against any other location around the base or over the crown of the skull. Likewise, some embodiments may incorporate single, dual, or multiple BC oscillators 200 each of any appropriate size and in any appropriate configuration or orientation.

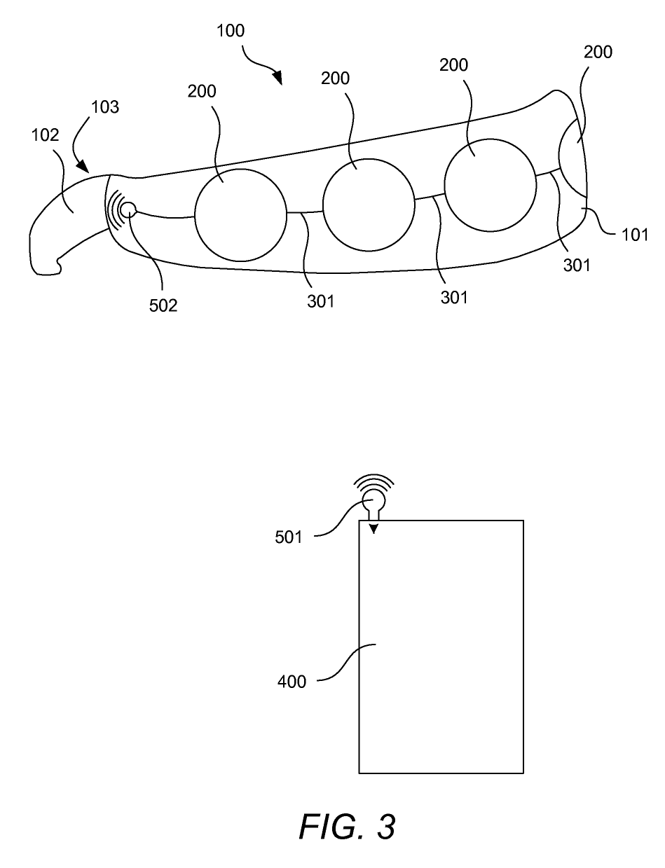

Further, with reference to FIG. 2, in some embodiments the BC oscillators 200 may be connected via appropriate wiring 300 to a corresponding suitable signal producing unit 400. Alternatively, in some embodiments the BC oscillators 200 may receive a corresponding signal from a suitable signal producing unit 400 using wireless technologies and associated devices such as Bluetooth, wireless local area network (WLAN), radio frequencies (RF), Wi-Fi, wireless routers, infra red data association (IrDA) and infrared wireless or any other equivalent short or long range wireless technologies and associated components 501 and 502 as depicted in FIG. 3. Furthermore, in some embodiments the BC oscillators 200 may receive a corresponding signal from a suitable signal producing unit 400 using proprietary wireless technologies and associated devices such as cellular frequencies.

As depicted in FIG. 2, in some embodiments utilizing wiring 300 and multiple BC oscillators 200, the BC oscillators 200 are interconnected by wiring segments 301. Likewise, in some embodiments the BC oscillators 200 are connected directly to a suitable signal producing unit 400 using a standard tip-ring-sleeve (TRS), tip-sleeve (TS) or tip-ring-ring-sleeve (TRRS) pin 302 and jack (not shown) stereo connection, of any suitable size (such as one-quarter inch, one-eighth inch, etc.). In this manner the BC apparatus can be used independently. Alternatively, as depicted in FIG. 2, the BC oscillators 200 of the BC apparatus can be connected to a splitter 600 which is subsequently connected to a suitable signal producing unit 400. Using a splitter such as splitter 600 allows the BC apparatus to be used in conjunction with any corresponding audio listening components such as any type of headphones 700 (shown in dashed lines) or any other second audio listening components. Similarly, in embodiments utilizing wireless technology, the wireless BC apparatus can be used independently or in concert with any wired or wireless audio listening components. The ability to use the BC apparatus independently or in concert with any second audio listening components provides broad versatility while maximizing user enjoyment and comfort.

The signal producing unit 400 may be a personal audio listening device such as an audio cassette player, compact disc player, MP3 or other digital media player, a telephone headset or a personal hearing aid and equivalent devices. Likewise, the signal producing unit may be a group audio listening device such as a mechanism for broadcasting a translation to multiple recipients during a group presentation. Further, the signal producing unit may be a communications device adapted to facilitate audio contact between military personal, emergency personal, flight crews and other groups of users requiring intercommunication. Likewise, the signal producing unit may be outfitted with any suitable features or associated accessories such that it can be comfortably and conveniently used throughout a range of physical activities such as a strap, a clip or any other equivalent features or accessories.

In some embodiments the BC apparatus, as depicted in FIG. 1, surrounds the entire circumference of the user's head thereby facilitating substantially constant and consistent contact between the apparatus (in this case embodied in headband 100) and the users head. Furthermore, the BC oscillators 200 can be placed throughout the apparatus thereby ensuring that the oscillators 200 remain in contact with the user's head at numerous locations. In this manner the BC apparatus provides clear and consistent sound quality. Additionally, the BC apparatus is fully adjustable such that it can be tightened or loosened by means of the loose ends 102 and 103 to achieve a comfortable fit while maintaining secure contact throughout a range of physical activities. Likewise, the BC apparatus can be removed between uses by slipping it off or by untying the headband 100.

In some embodiments the BC oscillator 200 or BC oscillators 200 depicted in FIG. 2 are constructed to be waterproof such that the associated apparatus in which they are incorporated can be washed or used in adverse environmental conditions such as while showering or swimming. In some embodiments the waterproof oscillators 200 can be incorporated into any type of headwear and used with any suitable signal producing device 400 without wiring. In this manner the suitable signal producing device 400 need not be worn while the associated apparatus is used in adverse environmental conditions. Moreover, in this manner there need be no limit to the storage capacity or battery life of an associated signal producing device 400 nor is the device an encumbrance on the user. Likewise, because the BC oscillators 200 are incorporated directly into any type of headwear, the BC oscillators 200 do not hinder or encumber the user in any manner. Consequently, the apparatus as presently described can be used comfortably during any physical activity without causing any interference to the user.

In some embodiments using wiring, the wiring can be temporarily disconnected to facilitate washing the apparatus. Likewise, in some embodiments the BC oscillators 200 can be attached such that they can be removed and subsequently reattached to different types of headwear or headwear of different colors to coordinate attire. Similarly, some embodiments may include features to improve wearing comfort, such as padding, sweat-absorbing features, etc. Some embodiments may also or alternatively include decorative features, such as logos, patterns, designs, etc.

In some embodiments the BC oscillators 200 are constructed substantially thinly such that the apparatus 100 can be comfortably worn under a helmet or mask suitable for combat, welding, construction, motorcycling, kayaking, sky diving, skateboarding, scuba diving, bicycling and the like. Likewise, in some embodiments the BC oscillators 200 are constructed such that they are substantially malleable thereby facilitating comfortable curvilinear placement around the head of an associated user. Alternatively the BC oscillators 200 can be integrally incorporated into such headwear directly. On the other hand, in some embodiments the BC apparatus can accommodate all oscillator designs and styles regardless of specific dimensions or degree of malleability.

In some embodiments the BC apparatus is capable of receiving and producing slight timing and intensity differences in associated audio transmissions such that stereo separation can be achieved. In this manner the BC apparatus is capable of producing an exceptional listening experience.

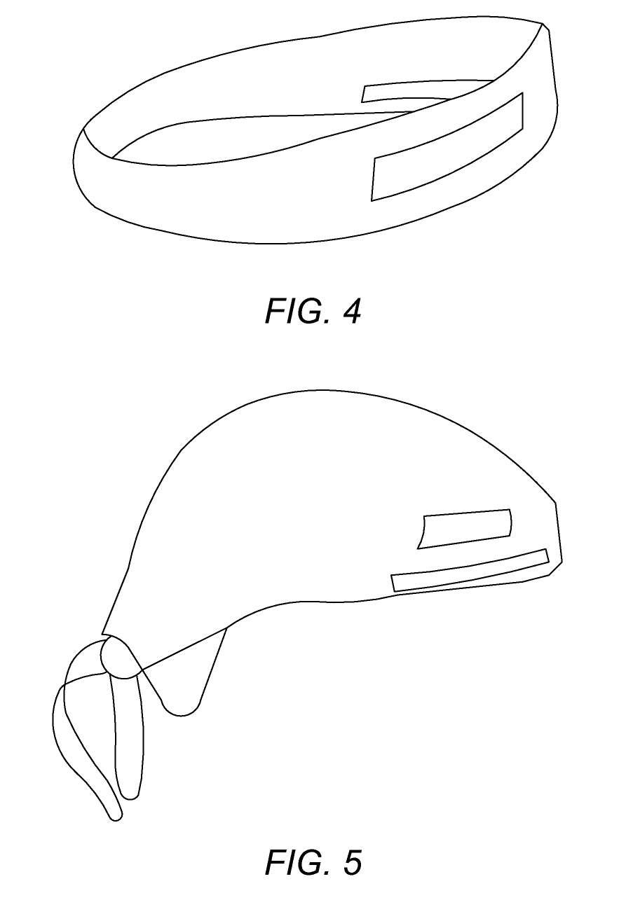

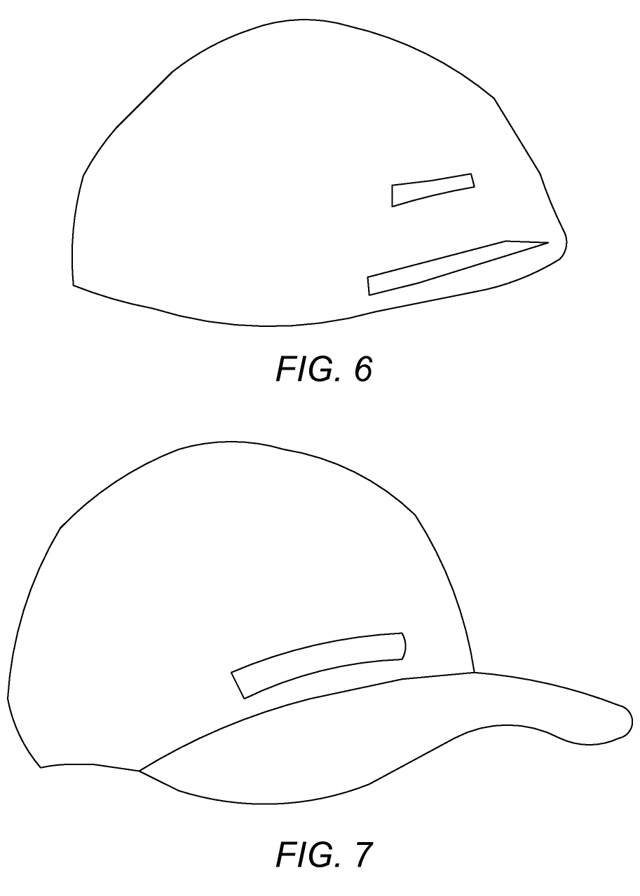

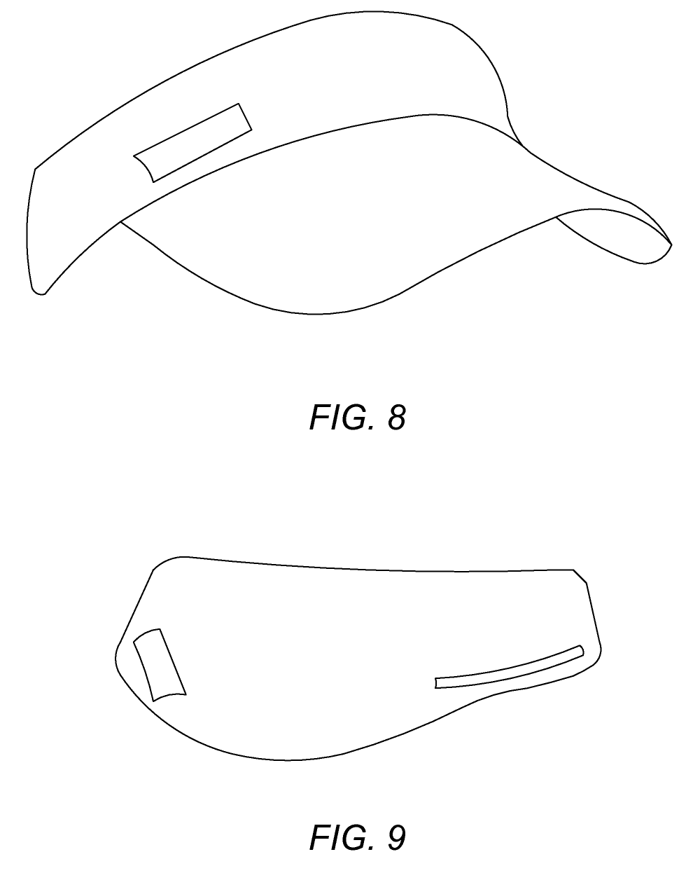

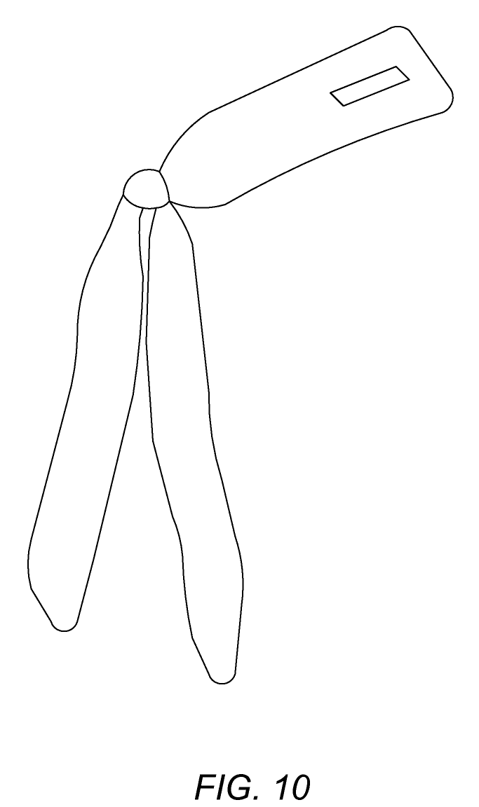

Additional exemplary embodiments of the proposed BC apparatus are depicted in FIGS. 4 through 10. The specific BC features and advantages previously discussed apply equally to these additional exemplary embodiments. Therefore, the embodiments depicted in FIGS. 4 through 10 are intended to depict additional aesthetic styles with some additional functionality such as increased protection to the user from adverse environmental conditions. However, these embodiments are illustrative only and thus are not intended to limit the scope of the proposed apparatus embodiments.

While the apparatus and methods of the present invention have proven to be particularly useful in the area of personal audio listening devices, those skilled in the art can appreciate that the apparatus and methods can be used in a variety of different applications to yield a comfortable, sleek and versatile bone conduction device.

The present invention may be embodied in other specific forms without departing from the spirit or essential characteristics of the invention. The described embodiments are to be considered in all respects only as illustrative and not restrictive. The scope of the invention is, therefore, indicated by the appended claims rather than by the foregoing description. Thus, all changes that come within the meaning and range of equivalency of the claims are to be embraced within their scope.

What is claimed is:

1. An apparatus for auditory bone conduction, comprising:
an article of substantially circumferential head attire; and
a bone conduction oscillator placed in the head attire so as to be securely held against a head of a user wearing the head attire to achieve substantially continuous contact between the bone conduction oscillator and the user's head, the bone conduction oscillator being adapted to be driven to produce auditory sound waves transmitted to the user by bone conduction; and
a signal producing unit connected to the bone conduction oscillator.

2. An apparatus as recited in claim 1, wherein the article of head attire substantially surrounds the circumference of the user's head extending substantially between a forehead and a base of a skull.

3. An apparatus as recited in claim 2, wherein the article of head attire extends over a crown of the head of the user.

4. An apparatus as recited in claim 2, wherein the article of head attire extends over at least one location of the user's head and face.

5. An apparatus as recited in claim 1, wherein the bone conduction oscillator is disposed at a discrete location along a length of the article of head attire.

6. An apparatus as recited in claim 1, wherein the bone conduction oscillator is disposed continuously along a length of the article of head attire.

7. An apparatus as recited in claim 1, wherein the article of head attire comprises a plurality of bone conduction oscillators.

8. An apparatus as recited in claim 7, wherein the plurality of bone conduction oscillators comprises bone conduction oscillators disposed at discrete locations along a length of the article of head attire.

9. An apparatus as recited in claim 7, wherein the plurality of bone conduction oscillators comprises bone conduction oscillators disposed continuously along a length of the article of head attire.

10. An apparatus as recited in claim 1, wherein the bone conduction oscillator is waterproof.

11. An apparatus as recited in claim 1, wherein the bone conduction oscillator is substantially flat and substantially malleable.

12. An apparatus as recited in claim 1, wherein the bone conduction oscillator is adapted to receive auditory sound waves from the signal producing unit by a transmission means selected from the group of:
appropriate wiring; and
wireless transmission.

13. An apparatus as recited in claim 1, wherein the bone conduction oscillator is attached to the article of head attire in a manner selected from the group of:
detachably affixed to the article of head attire; and
integrally formed with the article of head attire.

14. An apparatus as recited in claim 1, wherein the at least one bone conduction oscillator is adapted to transmit sound waves incorporating timing and intensity differences such that stereo separation is achieved.

15. An apparatus as recited in claim 1, wherein the article of head attire is adjustable such that the apparatus can be worn comfortably throughout a range of user head sizes and a range of physical activities.

16. A method for using an auditory bone conduction transmission apparatus, comprising:
providing a removable and wearable article of substantially circumferential head attire;
providing a bone conduction oscillator attached to the head attire, wherein the bone conduction oscillator and the head attire are adapted to be comfortably worn for long periods of time and in a variety of activities with the bone conduction oscillator maintained in substantially constant contact with a head of a user; and
wearing the head attire outfitted with the bone conduction oscillator.

17. A method recited in claim 16, further comprising transmitting a comprehensive range of personal auditory sound waves via bone conduction of the bone conduction oscillator.

18. A method recited in claim 16, wherein a complementary air conduction device is used in concert with the bone conduction transmission apparatus by means of a splitter outfitted with a jack adapted to accept a pin connector.

19. A method recited in claim 16, wherein the bone conduction transmission apparatus is removably worn in concert with head attire suitable for a range of physical activities.

20. A method of making an auditory bone conduction transmission apparatus, comprising:
providing an article of substantially circumferential head attire;
detachably affixing at least one bone conduction oscillator to the head attire; and
detachably connecting the at least one bone conduction oscillator to a suitable signal producing unit by appropriate means for connecting.
